(19) United States
(12) Patent Application Publication
(10) Pub. No.: US 2006/0090131 A1
(43) Pub. Date: Apr. 27, 2006

(54) Multi-media user terminal for a presentation medium

(76) Inventor: Hiroyuki S. Kumagai, Boulder Creek, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 11/059,176

(22) Filed: Feb. 15, 2005

Related U.S. Application Data
(60) Provisional application No. 60/622,487, filed on Oct. 26, 2004.

(51) Int. Cl. G06F 3/00; G06F 17/00; G06F 9/00

(52) U.S. Cl. 715/700

(57) ABSTRACT

Mass electronic-commerce (e-commerce) user terminal is disclosed, which enables mass television (TV) viewers to participate in e-commerce using new and existing business infrastructures. The multi-media user terminal makes a direct, real-time, instantaneous connection between products featured in TV commercials/programs (or other event such as a movie in a theater) and the existing web-based business infrastructure directly through the multi-media user terminal device. The multi-media user terminal provides real-time two-way communication with the TV viewers and the business entities. The device will also provide the TV viewing information for TV rating on real-time basis.

### RELATED APPLICATIONS

This application claims priority under 35 USC § 119 to U.S. Provisional Application No. 60/622,487, titled “Mass E-Commerce User Interface Terminal and E-Commerce Process,” filed Oct. 26, 2004, the contents of which herein are incorporated by reference.

### BACKGROUND OF THE INVENTION

1. Technical Field of the Invention

The present invention relates to an electronic user interface, which makes instantaneous connections between the television viewers and products/services being featured on the television commercials and programs.

2. Description of Prior Art

Real-time information of what television viewers are watching is valuable information by itself. The rating of television program determines the fate of commercial television programs, because ratings often determine the advertisement value of the given television program. In the past, this information was gathered in a form of viewer survey (questionnaire/television viewer journal) on paper, typically conducted by a third party, media research company whose purpose is to gather such information (for example, the rating system by Nielsen Media Research). Nielsen Media Research in particular is in a process of transitioning from paper journal to an electronic logging system. Their system is called “People Meter”, which consists of a computer that is set up on the TV set and a special remote control. During the survey, everyone in the house hold is assigned a “button” on the remote control. Every time one watches a TV program, he or she is asked to push his or her assigned button on the remote control. The computer on the TV set will log what program is on the TV, and who in the family is/are watching.

Television commercials are the main revenue source for the commercial television networks, stations and program producers for the history of commercial television. However, for the product manufacturers, distributors, retailers and service providers (the Sellers), there is no direct feedback or the instantaneous sales from the viewers they are trying to reach (the Buyers). Direct connection of television commercial and sales was first attempted with telephone calls, toll-free or otherwise, then the Internet web address broadcast during the commercials, with a various levels of success.

When a Seller broadcasts the necessary contact information in a television commercial, Buyers typically have no time to make a telephone call, or even to write down the necessary information to complete the sales transaction during the TV commercial. With today's trend of short television commercials (as short as five seconds) due to high cost of television air-time, it is getting increasingly difficult for the Sellers to imprint the Buyers with the necessary information (i.e., the contact information) to sell the products and services, let alone to actually complete the sales transactions.

Extensions to these sales via television commercials are infomercials and television shopping networks. However, they miss the majority of the mainstream television viewers, i.e., the Buyers due to various reasons; these infomercials are broadcast during the non-prime time television time slot since the air-time in what is considered the prime television viewing time in the evenings is too expensive; a TV shopping channel fails to draw the mainstream viewer, because for most of the TV viewers, shopping is not the main reason to watch television.

Sales of various products and services have been successful via Internet. The web based business on the Internet created the concept of “virtual shopping cart” where a shopper will create a list of items to purchase on the Internet. At the end of the Internet session, user goes through a “check-out” process on-line and completes the sales transaction using a credit card. Some Internet based vendors also have “one-click shopping” where the users pre-register the credit card information and sign-off the agreement that a single action (mouse click on a special icon on the screen) will complete the sales transaction (e.g., Amazon.com). Typically these orders are filled and the merchandise is shipped directly to the customer.

Although Internet based sales has grown dramatically in the recent years, they failed to make direct connections to the television advertisement. Also, the Internet based-sales require the Buyer to use a computer. There are many people who are intimidated by the computers. Even if there is a computer in the household, current trend in a typical home shows a physical separation between the television and computer (they tend to be in different rooms). Therefore, there is no connection between television commercial and web based sales, other than aforementioned web address on the television commercial. In this manner, there is no way to synchronize the advertisement on the television and the advertisement/sales on the web page.

Even if business entities, such as Gemstar TV Guide On-Line® try to attract the television viewer by free television listing information, the advertisement vehicle (the internet sales infrastructure) is not a true companion to the television. From the Seller's point of view, the Internet based sales are attractive in many ways, one of which is it is easy to integrate the sales to the company internal inventory system and its external supply chain network, which may be local or global. Other computerized point-of-sales devices (cash register, wireless point of sales devices, etc.) have been integrated in this manner for various types of business.

Most television viewers want television listing service. The fact that the Gemstar's TV Guide® publications (hard copy magazines available for paid subscriptions or sales at magazine stands) have been a successful business is one example of such a business model. Gemstar also has an Internet based service, TV Guide On-line®, which provides the identical television listing information free of charge to the end user, in exchange for the advertisement space. Cable television and Direct Satellite television service providers also provide the identical information on a television screen, which also creates the opportunities for the merchandise advertisement. The television listing information is largely in public domain, since the television networks publish the listings.

Another attempt to link the television viewers to the sales infrastructure is the television set-top devices such as Cable TV interface box or an interface to Gemstar's TV guide. Both of these devices disseminate the TV program listing information free of charge with some advertisement.

Nevertheless, the above approaches have a number of problems that include: (1) no synchronization with television advertisement; (2) interruption of television viewing because the listing (and more importantly, the advertisement) display is on the television screen; and (3) a limited amount of information that can be displayed due to the low resolution of the current television screen, including on the new High Definition Television (HDTV) standard because it is (and will continue to be) difficult to upgrade the resolution as it is locked into the present HDTV standard.

### SUMMARY OF THE INVENTION

The present invention relates to an electronic user interface, which makes instantaneous connections between the television viewers and products/services being featured on the television commercials and programs. One embodiment includes a software-hardware integrated device. It creates opportunities for business entities to have a new avenue to advertise and to complete business transaction. It also provides information on what television program viewers are watching on a real-time basis. A benefit to users/consumers is that it provides information on TV programs, and the device also acts as universal remote control. When the device is integrated in the e-commerce infrastructure, it also serves as an “electronic shopping list” service.

In one embodiment, the present invention includes an electronic device and the business infrastructure enabled by the device, which together link the television viewers to the Internet-based sales instantaneously without use of a conventional computer. This link can be synchronized with the television commercials, and the sales transactions can be completed immediately, or delayed until the viewer visits a retail store at a later date. This electronic device also provides accurate, real-time information on which television program viewers are watching.

In one example embodiment, the electronic device may be configured as a web browsing tool, and may also be used as a television/cable/satellite remote control. As a web browser, it is capable of displaying any advertisement, and includes means to complete a sales transaction. In some embodiments, there will be no maintenance and administration requirement as is required by conventional computer systems, because the electronic device is designed with the embedded systems technology. Hence, the electronic device is configured to function as an appliance, rather than as a conventional computer system.

In one embodiment, the electronic device is a multi-media user terminal (MUTe). The multi-media user terminal enables the information provider, which disseminates television listing information to an end users' terminal, to be a hub of electronic commerce (e-commerce). Because the multi-media user terminal is configured for two-way communication with the information provider's web site via Internet, when the user activates a control feature to change a channel (e.g., similar to a conventional remote control changing channels on the television or a set top box), the information provider receives information on which channel the viewer is watching.

If the information provider has access to the advertisement schedule from a content operator, e.g., a cable/satellite operator (note: the TV signal provider can become the information provider), the information provider will have the exact knowledge of what TV advertisement (or products and services featured in the program, for example, automobile in the movies) the TV viewers are exposed to. At this moment, the information provider can provide the opportunities for the end-users to purchase products and services featured on the TV commercials and programs on-line instantaneously (i.e., the “Buy” button on the multi-media user terminal screen). Alternatively, the device allows the users to place the product or services in the “virtual shopping cart” for a purchase as at a later date. In some embodiments, sales transactions can be configured to pass through the information provider so that the information provider can profit from the sales commission of each sale, as well as from the advertising on the multi-media user terminal.

In addition, one embodiment of the present invention also includes a business infrastructure that can be supported by an embodiment of the multi-media user terminal. It integrates the existing Internet-based sales infrastructure to the television commercials; it provides new opportunities for a retail store (small local stores to nation-wide chain) to “pop” an advertisement on the device while a manufacture is running an advertisement; it enables the information provider to be in the hub of electronic commerce.

It is noted that many sellers already have direct sales mechanism. In addition, many already have a web presence. The multi-media user terminal may be configured to directly link buyers to a seller's web site on real-time basis, without compromising the buyer's TV viewing experience (i.e., buyer doesn't have to leave the TV to get on the computer; an advertisement or sales information does not block the TV screen).

Further, many sellers may not have an existing direct sales infrastructure (e.g., many of manufacturers and distributors of grocery items fall into this category). The multi-media user terminal (and supporting architecture platform) allows such businesses to gain benefits provided by the system. For example, some large grocery stores already have consumer database in a form of “discount club membership.” By linking the consumer's information with the multi-media user terminal, these stores can leverage the multi-media user terminal to “pop” the “Buy” button when a grocery item in a TV advertisement appears on the TV screen. To take the concept further, as some of these stores already have home delivery order system to which the order can be linked, or alternatively, the store can simply hold the information on what the buyer wishes to buy on their database. Thereafter, when the buyer visits the store next time, the order can be filled.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The present invention includes other advantages and features that will be more readily apparent from the following detailed description of the invention and the appended claims, when taken in conjunction with the accompanying drawings, in which:

Figure (FIG.) 1a illustrates one embodiment of a multi-media user terminal in accordance with the present invention.

FIG. 1b illustrates one embodiment of an architecture for a multi-media user terminal in accordance with the present invention.

FIG. 1c illustrates one embodiment of a commerce system including a multi-media user terminal in accordance with the present invention.

FIG. 2 illustrates one embodiment of a block diagram of sales transaction of the existing commerce process involving television commercials.

FIG. 3 illustrates one embodiment of a block diagram of the consumer information flow of existing commerce process involving television commercials.

FIG. 4 illustrates one embodiment of a block diagram depicting the sales transaction with operation of the device in the loop

FIG. 5 illustrates one embodiment of a block diagram depicting the consumer information flow with operation of the device in the loop.

### DETAILED DESCRIPTION OF THE INVENTION

A preferred embodiment of the present invention is now described with reference to the figures where like reference numbers indicate identical or functionally similar elements. Also in the figures, the left most digit(s) of each reference number correspond(s) to the figure in which the reference number is first used.

Multi-media User Terminal Architecture

Figure (FIG.) 1a illustrates one embodiment of a multi-media user terminal 110 in accordance with the present invention. The multi-media user terminal 110 may be structured as a hand-held electronic device that includes appropriate user interface hardware and software for graphical display and tactile interaction. In one embodiment, the multi-media user terminal may be structured to have a form factor of a conventional hand-held device, for example, a conventional large universal remote control device, a personal digital assistant, a data-enabled cellular phone, a tablet computer or the like.

The multi-media user terminal 110 includes a screen (or display) 115, a controls area 120, and an optional keypad 125. The screen 115 may be a liquid crystal display (LCD) or plasma screen and functions to display information on the multi-media user terminal 110. In some embodiments, the screen 115 may be a touch screen through which commands and other information may be entered into the multi-media user terminal 110 directly through interacting with the screen.

The controls area, generally 120, includes control mechanisms for the multi-media user terminal 110. For example, buttons (or switches) 120a for specific tasks such as “select” (or “enter”) or customizable buttons to assign tasks. In another example, the controls area 120 may also include other control mechanisms 120b such as a track ball, a mouse, a jog dial or roller. It may also be integrated in the aforementioned touch screen display 115.

The keypad 125 is optional and may be configured with a miniature QWERTY keyboard (or equivalent) and/or a numerical or symbol pad. In embodiments without a keypad 125, the multi-media user terminal 110 may be configured to include “soft” keyboard that is displayed on the touch screen when necessary to input information or otherwise interact with the device, e.g., inputting credit card information.

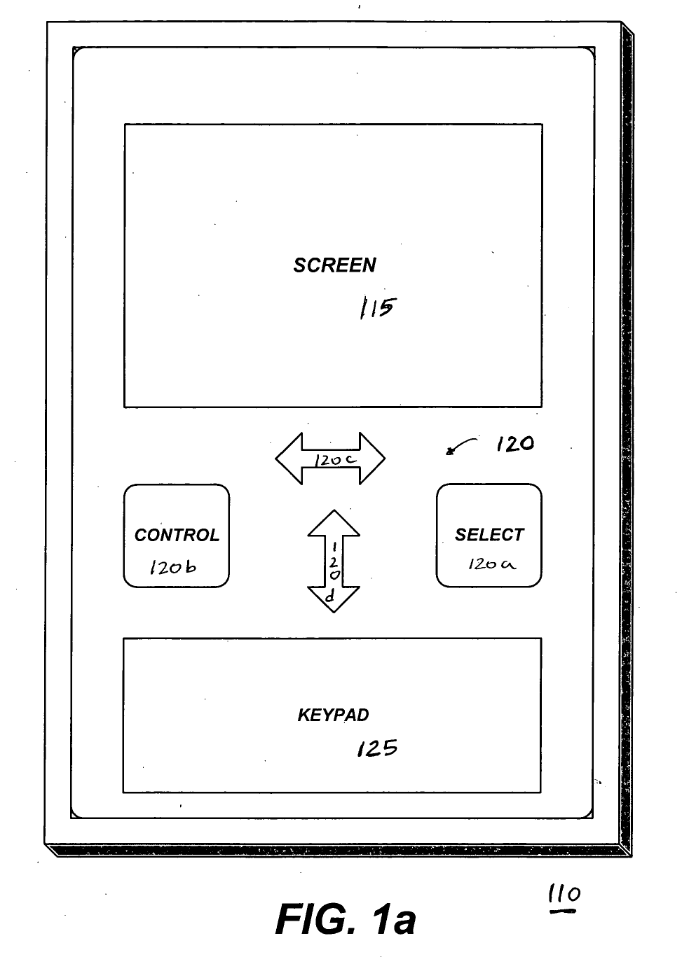

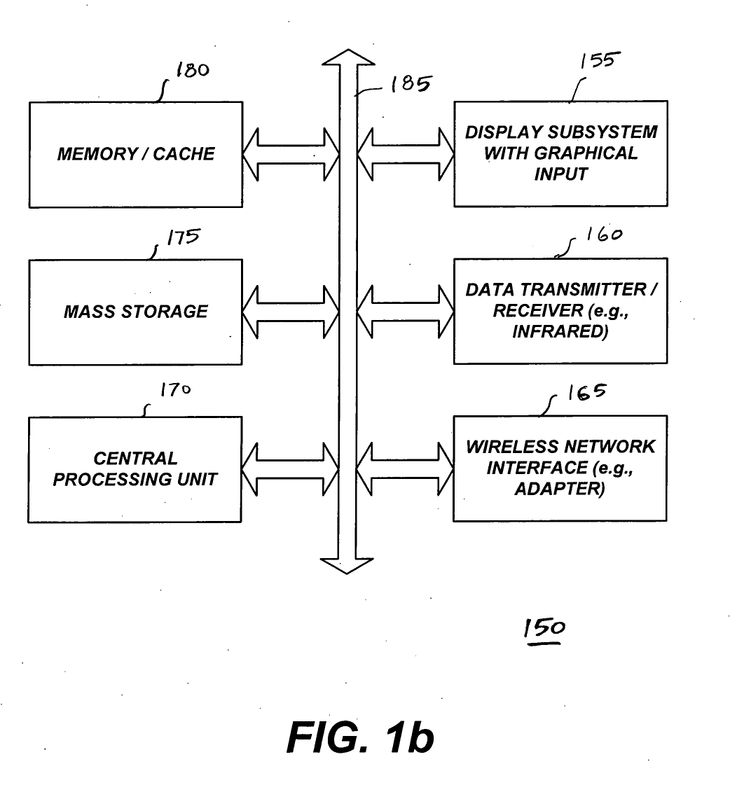

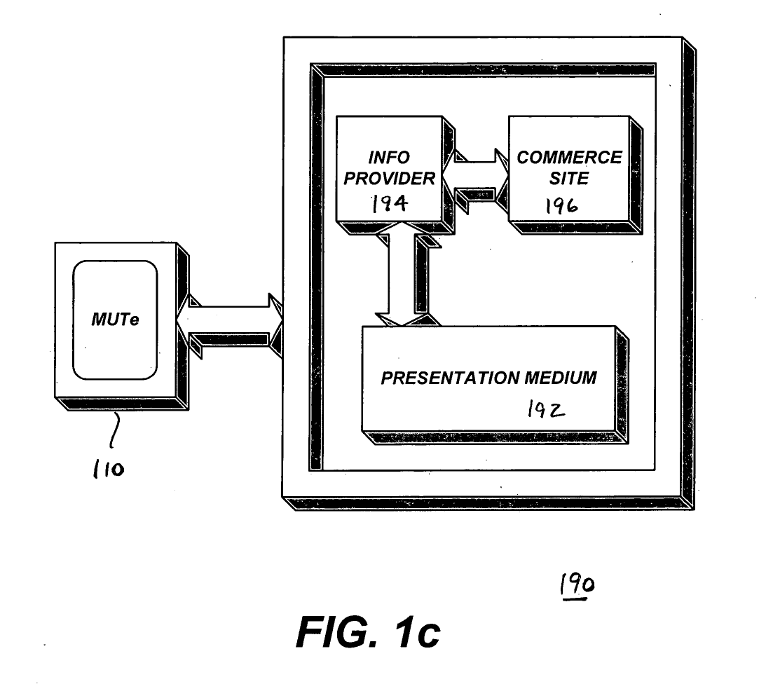

FIG. 1b illustrates one embodiment of an architecture (or system) 150 for the multi-media user terminal 110 in accordance with the present invention. The architecture 150 includes a display subsystem 155, which may include an optional graphical input for touch screen embodiments, a data transmitter and receiver subsystem 160, a wireless network interface subsystem 165, a central processing unit or controller 170, a mass storage medium 175, and memory/cache 180. The components 155, 160, 165, 170, 175, 180 of the architecture 150 are coupled through a data bus 185, and generally, may be conventional components.

The display subsystem 155 is configured to display graphics, images and text data on the multi-media user terminal 110. The data transmitter and receiver subsystem 160 is configured to provide a communication interface and link, e.g., infrared or Bluetooth, with a presentation medium, e.g., a television, radio, or multi-media computing configuration. The wireless network interface subsystem 165 is configured to provide a communication interface and link, e.g., an adapter and appropriate drivers or wireless communication enabled chipset, with a network, e.g., a local area network (LAN) and/or a wide area network (WAN) such as the Internet. Note that although the system is described in a wireless configuration, those skilled in the art will recognize that the principles described herein also apply to wired configurations.

The central processing unit 170 is configured to provide processing functionality for the multi-media user terminal 110. The mass storage 175 provides optional non-volatile storage, e.g., a disk drive or solid state memory drive. The memory/cache 180 are configured to provide volatile memory functionality. The data bus 185 enables signal communication between the components.

The system also includes a power management subsystem (not shown) that couples with a power source, e.g., power receptacle (AC) or batteries (DC), and manages power to and usage for the components in the architecture 150. An example of an AC/DC power configuration may include a rechargeable battery that can be configured for charging using a recharging stand or a built-in, quick-disconnect battery charger.

In one embodiment the multi-media user terminal 110 is configured as a dedicated web browser having an integrated infrared (or radio frequency) remote control-type function. The firmware for web browsing and remote-control functionality may be configured as instruction sets and stored in the system in the mass storage 175 for execution by the central processing unit 170. In this embodiment, the multi-media user terminal 110 displays information, for example, TV listing information, via existing Internet web technology directly onto its screen 115. In such a dedicated functional embodiment, the multi-media user terminal 110 is designed as an appliance that requires little, if any maintenance (other than routine maintenance, e.g., recharging or replacement of a battery).

FIG. 1c illustrates one embodiment of a commerce system 190 including the multi-media user terminal 110 in accordance with the present invention. The commerce system 190 includes a presentation medium 192, an information provider 194, and a commerce site 196. The presentation medium 192 communicates with the information provider 194. The information provider 194 communicates with the commerce site 196. In one embodiment, the information provider 194 may include the commerce site 196.

The presentation medium 192 also communicates with the multi-media user terminal 110, for example, in the form of a information broadcast. The information provider 194 also communicates with the multi-media user terminal 110, for example, through an Internet connection. The information provider 194 is configured to synchronize a presentation on the presentation medium, e.g., a television broadcast, with information relating to that broadcast on the multi-media user terminal 110. Examples of a presentation include a television program, a theater program, a radio program, an advertisement, or the like.

A presentation may have associated with it a placement. The placement may be, for example, a specific product setting such as a carbonated soda held by an actor in a television program, an Internet web site such as a web site for a grocery store or a web site for a product in an advertisement, or a specific forum information such as advertising for a concession stand in a theater. The information provider 194 synchronizes the appearance of the placement with associated information from an Internet web site or other medium that, in turn, can be pushed down to the multi-media user terminal 110. It is noted that in alternative embodiments, the placement may be for a service rather than a product, for example, an investment service advertisement with associated web site for the investment service.

Depending on how the multi-media user terminal 110 is configured, a uniform/universal resource locator (URL) of the web site or the web pages themselves associated with a placement on the presentation medium appears on the screen 115 of the multi-media user terminal 110. A user of the multi-media user terminal 110 may now interact with the URL or web page. For example, if the presentation is a television broadcast and therein is an advertisement for Coca-Cola®, the user's multi-media user terminal 110 may be directed to a URL for a web site for Coca-Cola®, e.g., www.cocacola.com, or to the web site itself. Thereafter, the user may be provided the option of visiting the URL, e.g., by selecting the “select” button 120a or if the web page is displayed using the “select” button 120a to add Coca-Cola® to a grocery shopping list. The grocery shopping list may be a stand alone application hosted on the multi-media user terminal 110, a program hosted by the information provider 194, or a program associated with the commerce site 196, e.g., a grocery store web site that allows a user to maintain a grocery list.

In alternative embodiments, in contrast to a typical computer-based web browser, the multi-media user terminal 110 may be configured so that a presentation listing, e.g., a television listing, runs on a “captured web browser” mode so that an end user cannot enter a URL into the device. In such embodiments the information provider 194 is provided complete control over which URL the multi-media user terminal 110 can connect to, thereby creating a captive audience for presentations such as advertisements and sales transactions. Of course, other alternative embodiments may allow a user to enter a URL information through the graphical user interface of the multi-media user terminal, or other input mechanism such as a keyboard, joystick, or mouse. It is noted that in embodiments in which the multi-media user terminal 110 has its own display subsystem 155, presentation viewing is uninterrupted.

Referring now to additional details on the structure and function of the multi-media user terminal 110, it may be configured in a modular format. This allows easy hardware upgrade, such as replacement of the display system (e.g., from LCD to high definition plasma independent of TV resolution standards) or of the wireless communication system (e.g., from IEEE 802.11 to IEEE 802.16). Moreover, the modular design allows for upgrades to more sophisticated system components as they become available, e.g., higher screen resolution, battery and its charging system, Internet/information network access method, etc.

Likewise, the software for the multi-media user terminal is also modular. It may be upgraded via Internet downloads (either wired or wireless). An operating system, if any, and web application software of the multi-media user terminal can reside on a fast mass storage device, e.g., a solid state storage device or other storage to store media such as a mini hard disk, and can include read/write mass storage functions. The software can be configured to accept various plug-ins. For example, aforementioned Nielsen Multimedia Research's people meter can be integrated to the multimedia user terminal in more user friendly fashion than the current hardware button on a remote control. For instance, each button assigned to a person can be a soft keyboard button on the multimedia user terminal with individual's name displayed.

The multi-media user terminal 110 may also be configured to include learning capabilities (e.g., using infrared (IR) signals received from the presentation medium, e.g., the cable/satellite television remote). The learning capabilities can be categorized in two separate categories. The first category is a universal remote control programming mode: This is an existing programming method available in conventional universal remote controls. It reads the IR signal generated by each button of the original remote control and copies them to the memory. This method may require a programming effort on end user's part.

The second category is an automatic learning mode. This mode becomes possible when the information service provider 194 has a prior knowledge of the cable/satellite receiver and its remote control functions. This mode may be configured by leveraging knowledge of the IR signal the end user is using. For example, if a cable or satellite television operator becomes the information provider 194, the multi-media user terminal 110 can sense the IR signal from the original remote control, then communicate with the cable/satellite company web site, to find out the requested result (change of television channel, etc.) This way after recording enough events, the multi-media user terminal 110 can duplicate the functions of the original cable/satellite remote control without any effort on the end user's part. Some reasoning capability (artificial intelligence approach) can be integrated to extrapolate the IR remote behavior, e.g., if a few of the IR commands representing numerals of the IR remote control, it is easy for the multi-media user terminal 110 to reason the rest of numeral commands.

It is noted that this remote control function is not limited to the television/cable/satellite receiver. It can be expanded to other devices with IR/radio frequency (RF) remote controls, such as Video Cassette Recorder (VCR), Digital Versatile Disk (DVD) and DVD recorder, house security and lighting system, and the like. Moreover, because the user terminal may be configured for consistent connection with the Internet, is it possible for a user to reach the user terminal from a remote location, e.g., computer in the office. This enables the user to control the household devices remotely. For example, a user can command a VCR or a DVD-R to record a TV program while that user is not in the house, e.g., from a computer in his or her office without an additional device or subscription service such as TiVo®, or control the house lighting, or security feature in the user's home.

The multi-media user terminal 110 may also be configured to include a built-in computer/web browser, which in one embodiment can be structurally configured to look and feel like a universal remote control or handheld entertainment device (e.g., MP3 type player or entertainment-like personal digital assistant (PDA)). Since the multi-media user terminal 110 is independent of the presentation device, i.e., the terminal 110 may be configured to function independent of the presentation medium, the design and construction is scalable.

As noted above, one embodiment of the terminal device may include an infrared (IR) cable/satellite TV or remote control feature, so that when the user “clicks” the channel icon on the screen, it will send the IR signals to change the TV/cable/satellite channel. As an Internet enabled device, the multi-media user terminal 110 can be configured to maintain a two-way communication with the information service provider 194 and/or a commerce site 196. This gives the service provider what channel (television program) each end user is viewing at any given moment.

Network access for the multi-media user terminal 110 may be configured to conform to an industry standard infrastructure in place at any given moment. For example, initially, it can be IEEE 802.11b, a, g, or n within the house, and via a modem (for example, phone, ADSL or cable/satellite television) to the Internet. New methods of network access can be integrated as they become available. The cost of such network (hardware as well as the monthly access fee) is negligible compared to potential revenue generated for the information provider in the form of sales commission and the like for the purchases that may be generated by the device and the e-commerce process.

The multi-media user terminal 110 is also configured to incorporate security features to prevent the unauthorized purchases. These security features include password based software key, as well as various hardware keys. The secure connection to web site is also included for protect user information. In addition the multi-media user terminal 110 may be configured to automatically integrate encryption for all transactions involved.

In one embodiment, the multi-media user terminal 110 may be configured as a companion to presentation mediums, e.g. as a device stays physically close to a television set. As the television viewer uses the multi-media user terminal 110 to change the channel on the TV (or the device senses an IR command transmitted from television/cable/satellite system remote control), the multi-media user terminal 110 transmits, via Internet, to the information provider 194 information about the channel the viewer is watching. This real-time information can be collected for further study (e.g., ratings analysis), while allowing real-time advertisement/purchase opportunity of the products and service featured on the television commercials and programs.

Communication between the multi-media user terminal 110 and the information provider 194 may be forwarded, e.g., sold, to producers of presentation programming, e.g., television programs and advertisements. The direct two-way communication path between the multi-media user terminal 110 and the information service provider 194 allows for a more detailed response from presentation viewers. For example, users may now be queried to complete a questionnaire directly from the multi-media user terminal 110 while watching a television program or commercial.

This type of communication can further aide the identification of viewer demographic, preferences and opinions. Viewers can participate in the television program more intimately than before, and it can even be used to cast a vote (popularity vote as well as political issues). In order to uniquely identify an individual, it is possible to integrate security mechanisms such as bio-metric sensor(s) (e.g., finger print or retina imager), authentication configurations, password access, and the like. Such security features may be of greater importance if the multi-media user terminal 110 is to be used for political voting, or for security of product and service purchases.

E-commerce Infrastructure and Processes

In one embodiment, application of the present invention is provided in the context of television (TV) for ease of understanding. (e.g., it can provide educational material with more detailed explanations of what's on the television program, or during emergencies, television stations provide “Emergency Broadcast Services”, the user terminal can display more detailed information on the nature of emergency and instructions to the public.) However, the principles disclosed herein also are applicable to other entertainment mediums such as movie theaters, live performances, sporting events, and the like.

In one embodiment a television signal provider (e.g., cable television or satellite television operators) has information on what product is being featured in television commercials and programs, which the television viewer is watching at any given time. This configuration provides an advertisement opportunity on the multi-media user terminal 110. The advertisement opportunity includes synchronizing the advertisement on the television with a purchase option available through the multi-media user terminal 110.

In one embodiment, the purchase is made through selection of a “buy” button on the multi-media user terminal 110. This action generates an instantaneous sales transaction. Note that selection may include, for example, pushing, depressing, touching, or pointing to through a pointing device (e.g., a mouse or touchpad). Further, the “buy” button may be hardwired into the multi-media user terminal 110 or may be an “icon” or “button” on the graphical user interface.

The multi-media user terminal 110 allows the information service provider 194 to be a hub of the e-commerce, and therefore, allows the service provider to profit from transactions involving the multi-media user terminal 110. However, in alternative embodiments, the information service provider 194 is not required to have the product/service sales infrastructure. The actual delivery of the products and services can be contracted out to a separate entity, which may already possess the appropriate infrastructure for such transactions. In such cases, the information provider will simply get a credit for the order (e.g., sales commissions) from the one who actually sells the products/services. In order to collect the credit (e.g., sales commissions), the information provider may need to compile a database on information such as who bought what from whom, how many, and other pertinent transaction information. This database is useful to collect the sales credit, but also provides other valuable data, such as information that represents a buyer preferences and media commercial effectiveness by area, demographics, and the like. Thus, the information becomes a very valuable and marketable commodity.

Depending on the products and services offered, there may be several ways to complete the sales transaction. For example, some product manufacturers may already have direct sales/shipping infrastructure in place. In such cases, these manufactures can buy the service from the information service provider to “pop-up” a buy button on the interface terminal, and may opt for the direct sales/shipping method to complete the transaction.

Other manufacturers may depend on the existing distribution and retail infrastructure. For example, a typical grocery item manufacturer depends on the grocery distribution network. In such cases, a grocery store can buy the advertisement slot from the information provider with an “add to the virtual shopping cart” button. Some grocery stores already have membership program with members profile database.

In one embodiment, a user interface on the multi-media user terminal 110 is configured to add a virtual shopping cart that is associated with each member profile, so that any store in the nation wide chain can access the user's virtual shopping cart. The sales transaction can be completed either via home delivery service, or a simple reminder service (add to the personal “shopping list” in the customer database) next time the user visits a store for shopping.

In case of some high pricing items such as automobiles and home mortgages, the transaction may be configured to complete the transaction later in time. For example, clicking on an icon on the multi-media user terminal 110 may begin sales negotiations involving a product or service. The level of “service completion” can be defined based on the user comfort level for a given products and services.

This new avenue of sales and information gathering provides TV program producers more efficient way of selling the advertisement time slot, immediate feedback in their program rating, and additional revenue (based on the synchronization of the icon of the advertisement on the device and the TV). This creates two separate marketable advertisement opportunities in the same time; one for a product manufacturer, and another for a retailer for a synchronized “buy” icon.

Alternatively, the retailer can purchase the display of “buy” icon from the information service provider. For example, the customer of the synchronized advertisement on the multimedia user terminal 110 can buy longer time slot on the user terminal so that the advertisement can “linger on” after the television commercial has ended so that the user has time to interact with the advertisement to complete the sales transaction. Thus, the present invention may be configured to enable a global supply chain, based on tracking and recording of instantaneous purchases. Moreover, the Internet helps eliminate the requirement for a physical location to trigger, manage, and meet the demand generated from the multimedia user terminal 110 anywhere in the world.

The viewer preference/tendencies, such as preference by state or region can also be compiled by the service provider for appropriate entities, such as TV network and product manufacturers. This information itself is a valuable commodity.

Additional Embodiment of Operation of the Multi-Media User Terminal

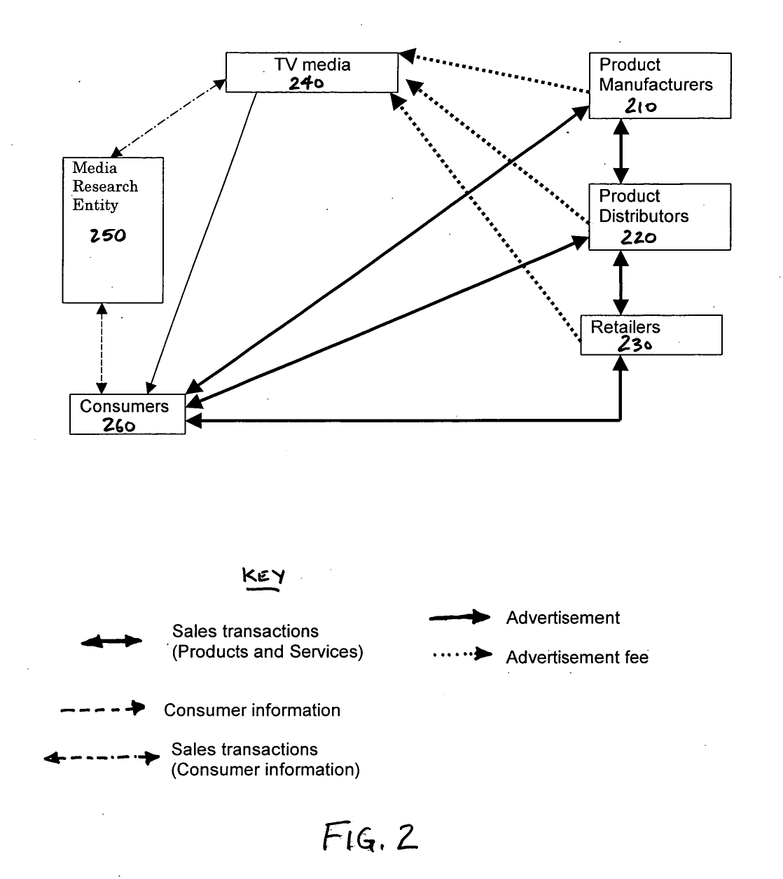

A conventional way businesses have utilized television media is depicted in FIG. 2. In a conventional approach, product manufacturers (or service provider) 210, product (or service) distributors 220, and retailers 230 contract with, and pay an advertising fee to, television media 240 to have the television media 240 air television advertisements in conjunction with programming. Generally, the product manufacturers 210, product distributors 210, and retailers 230 buy advertisement slots to air on television at particular times, and hope to reach a mass of consumers.

To help evaluate its audience and its demographics relative to its programming, the television media 240 may contract with a third-party media research entity 250, e.g., Nielson Media Research. The media research entity 250 polls a sample of consumer 250 to obtain and help analyze such data for the television media 240. The analyzed data may be used by the television media 240 to determine what advertisement fees to charge the product manufacturers 210, the product distributors 220, and the retailers 230.

Once the advertisements reach a consumer 260 through the television media 240, the consumer 260 then proceeds with appropriate sales transactions with the product manufacturers 210, the product distributors 220, and the retailers 230. For example, after viewing an advertisement for Coca-Cola® by the product manufacturer 210 and/or product distributor 220, the consumer 260 will go to a super market, i.e., the retailer 230, which may be advertising a sale on the product.

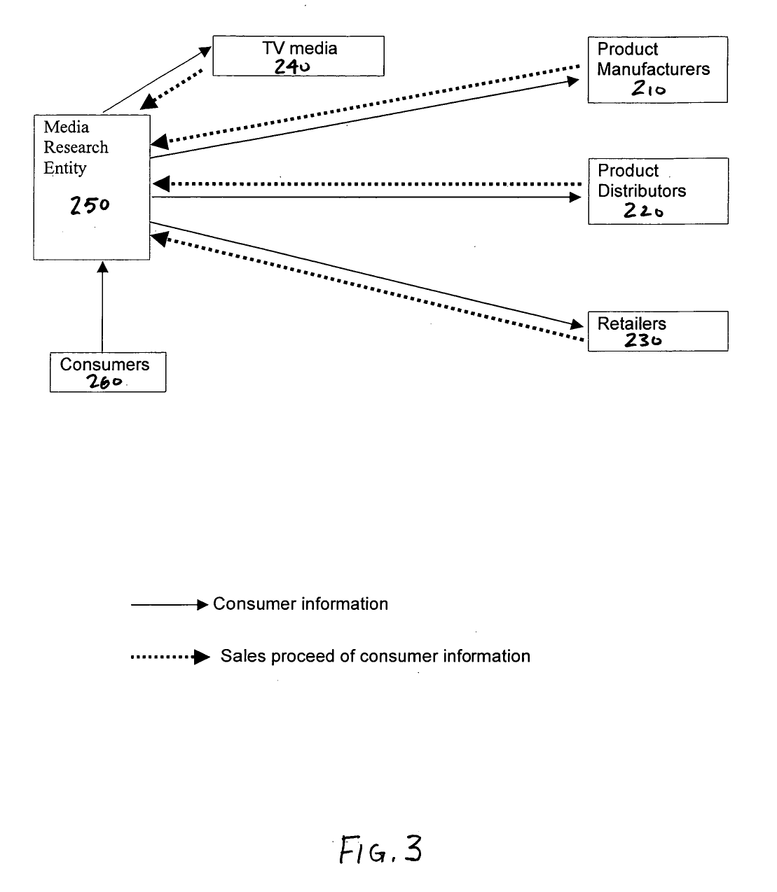

Turning to FIG. 3, it illustrates one embodiment of how the conventional third party media research company 250 keeps statistics on television viewers. Typically, the media research company 250 is the only entity that interacts directly with the television viewers. This interaction is commonly in a form of questionnaires and television viewing journals on paper, or the new electronic media such as Nielsen Media Research's People Meter. Information collected by the media research company 250 from the questionnaires and viewing journals is sold to the television media 240. It may also be sold to other commercial entities, such as the product manufacturers 210, the product distributors 220, and the retailers 230.

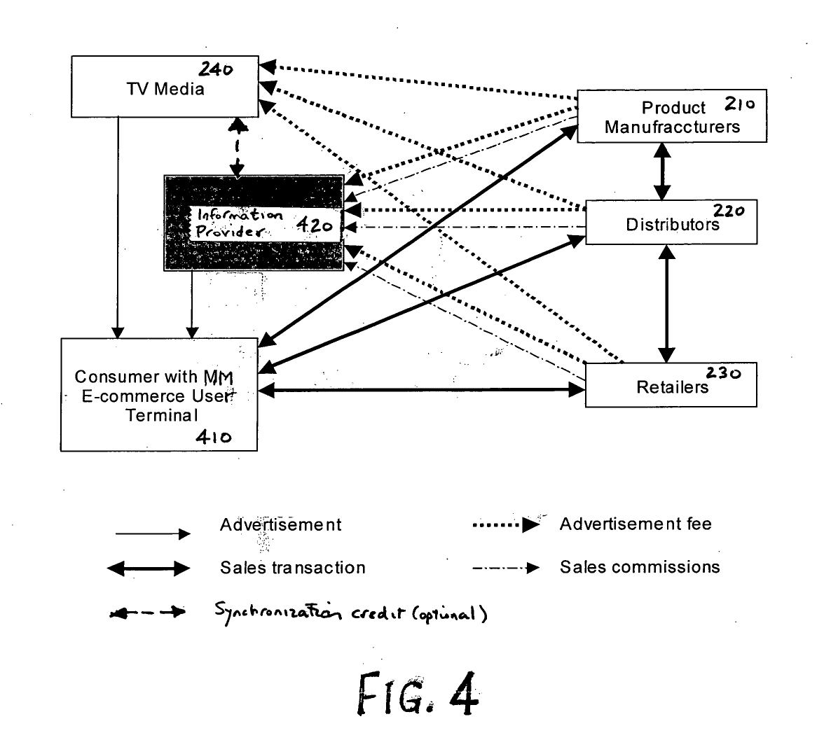

Referring now to FIG. 4, it illustrates one embodiment of a sales transaction that includes an embodiment of a multi-media user terminal 410 in accordance with the present invention. The multi-media user terminal 410 is structurally and functionally similar to the multi-media user terminal 110 previously described. In this embodiment, an information provider 420 communicatively couples with the product manufacturers 210, the product distributors 220, the retailers 230, and a user through the multi-media user terminal 410.

The information provider 420 is configured to synchronize an advertisement from the product manufacturer 210, the product distributor 220, and/or the retailer 230 with the multi-media user terminal 410 to complete a transaction (e.g., a sales transaction, a recorded coupon or discount, a request for additional information, etc.) between the user and the appropriate offering entity (i.e., the product manufacturer 210, the product distributor 220, and/or the retailer 230). Moreover, the information provider 420 also is configured to synchronize a placement (e.g., an advertisement) from the product manufacturer 210, the product distributor 220, and/or the retailer 230 with the appropriate programming from the television media 240 so that advertisements and programs can be synchronized with the multi-media user terminal 410.

Although a synchronized advertisement is preferable for use of the multimedia user terminal, the advertisement (or information broad cast in wider point of view) on television and the user terminal are not required to be synchronized. The advertisement slot on user terminal can be sold independent on the television (or other programming or event) advertisement slot. When there is no paying customer on the user terminal for the synchronized advertisement, the information provider can sell the advertisement slot on the user terminal at lower costs. Nevertheless, it is noted that in many instances synchronization provides for effective product and service marketing. Thus, an advantage of synchronization includes information of the television advertisement slot (e.g., what products and services are being advertised on what channel at what time) becoming a marketable commodity.

It is also noted that in alternative embodiments, placements (e.g., an actor inconspicuously holding their favorite carbonated soda during a dramatic scene) may be incorporated into a regularly scheduled program or event from the television media 240 and synchronized by the information provider 420 with the mass media user terminal 410. Thus, in such embodiments, the information provider 420 would provide a URL address to the multi-media user terminal 410 that takes the user to the web site for the product if the user selects the URL from on the multi-media user terminal 410. If selected, the user can complete a transaction on the web site associated with the URL through the multi-media user terminal 410. Alternatively, the information provider 420 may be configured to provide interfaces and processing capability to complete the transaction on its site, e.g., if it is configured as a web-based e-commerce site.

The system can be configured to provide financial or other credit to an information provider on transactions involving the multi-media user terminal 410. In addition, the television media 240 may also get a financial or other credit for such transactions that result from synchronization with the information provider 420.

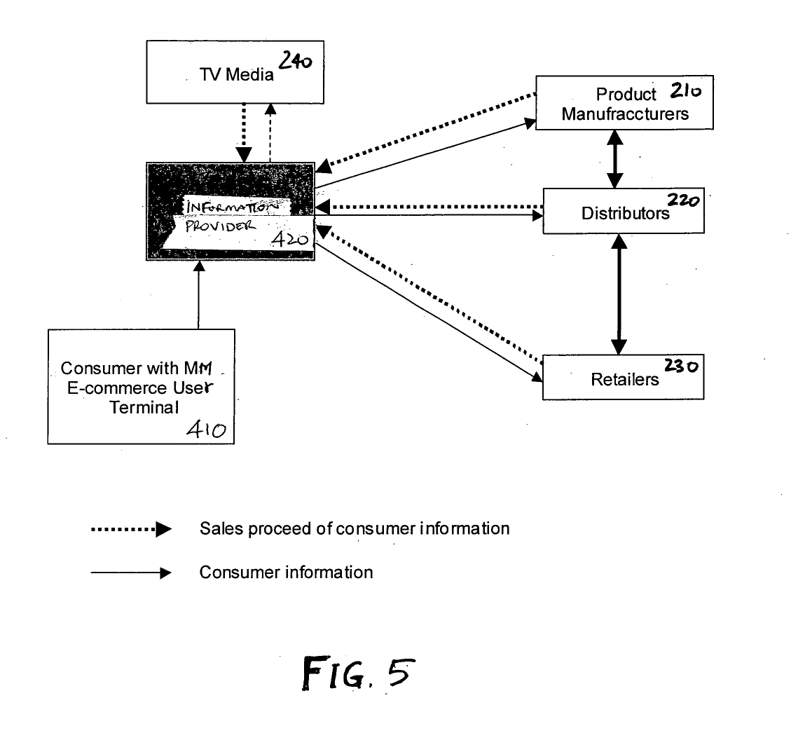

Turning to FIG. 5, it illustrates one embodiment of consumer information flow in accordance with the present invention. This embodiment further illustrates the information provider 420 receiving more accurate, detailed and timely viewer information, e.g., television viewing and purchasing trend, than conventional approaches taken by the media research company. Specifically, the information provider 420 is configured to obtain data from the television media 240 in the form of programming and relevant time information, obtain relevant demographic and purchasing information from the multi-media user terminal 420, and receive product placement related information from the product manufacturers 210, the product distributors 220, and/or the retailers 230. In turn, this collected, and optionally processed information, can be sold to the television media 240, and other entities (e.g., the product manufacturer 210, the product distributor 220, and/or the retailer 230) for fee on a batch or real-time basis.

Example of Use by Business Entities

The multi-media user terminal enables business entities, which provide information for consumption by users, to be a hub of the e-commerce. In the context of television viewing, the most appropriate information to disseminate is the television program listing. The television program listings are largely in public domain. Some companies such as Gemstar TV Guide, cable, satellite operators are already disseminating the information for free or on a paid subscription basis, or as a part of the television signal distribution service.

With the current digital cable or satellite television technology, the television signal distributors are in the most favorable position to become the information provider, thus the e-commerce hub, since they already have ability to know what channel viewers are watching, and have information on most television commercials at local, regional and National levels.

The multi-media user terminal may also be configured to learn infrared (IR) or radio frequency (RF) commands by observing the IR or RF signals while user uses a cable/satellite television converter remote control, and by communicating with the company computer on which channel user is watching. Since these companies often provide Internet access via same media, they may be able to provide the Internet access as a part of the television listing service to make the package more attractive.

Business entities, which do not distribute television signals, can also be the information providers and the e-commerce hub. These companies presently are not configured with technology that provides real-time information of TV viewer behavior. The multi-media user terminal, when programmed to be the replacement cable/satellite converter, can send the information directly to the company web server on real-time basis. For entities such as cable or satellite television programming companies, additional services and functionality may be bundled with the mass media user terminal, including terminal hardware, wireless home network hardware and Broadband Internet service free of charge or at a reduced rate. In one embodiment, these services and functionality may be compensated though advertisement fee on the multi-media user terminal, product sales commissions involving the multi-media user terminal transaction fees.

In another example involving the multi-media user terminal, the terminal could be configured for distribution or fixed availability in a movie theater. Thereafter, the terminal may be used to order or sell soda and other snack items in the theater, during the movie presentation. Likewise, in many theaters advertisements are displayed prior to viewing of a movie. The multi-media user terminal may be configured to work in conjunction with the advertisements to allow users to order products or information associated with each advertisement. Moreover, the multi-media user terminal can be configured with a slot or slide mechanism to accept a SIM card, smart card, credit card and so forth in order to “personalize” the multi-media user terminal for the duration of the consumers use before returning back to “public use” (i.e., for the next user to “personalize” it).

Upon reading this disclosure, those of skill in the art will appreciate still additional alternative systems and methods for a multi-media user terminal in accordance with the disclosed principles of the present invention. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. An apparatus for use in presentation environments, the apparatus comprising:
a provider interface configured to couple a signal from an information provider, the signal associated with a placement, the placement particular to a presentation; and
a user interface configured display data corresponding to the placement and configured to receive input for selection of information in the displayed data.

2. The apparatus of claim 1, further comprising a communications interface configured to transmit data corresponding to the selection to a third party.

3. The apparatus of claim 1, wherein the third party comprises one from a group consisting of a manufacturer, a distributor, or a retailer.

4. The apparatus of claim 1, wherein the third party comprises the information provider.

5. The apparatus of claim 1, wherein the user interface comprises a touch sensitive screen.

6. The apparatus of claim 5, wherein the user interface comprises a graphical user interface.

7. The apparatus of claim 1, wherein the user interface comprises a graphical user interface and a selection mechanism.

8. The apparatus of claim 1, wherein the data comprises a uniform resource locator (URL) from the information provider.

9. The apparatus of claim 7, wherein the user interface is further configured to display a web page associated with the URL in response to the selection.

10. The apparatus of claim 1, wherein the placement comprises an advertisement.

11. The apparatus of claim 10, wherein the data comprises advertising synchronized with the advertisement.

12. The apparatus of claim 1, further comprising a remote control device housing.

13. A method of interacting with a presentation medium, the method comprising:
activating the presentation medium;
establishing a communication link with an information provider in response to the presentation medium being active;
receiving advertising information from the information provider, the advertising information synchronized with a program from the presentation medium; and
displaying the advertising information from the information provider.

14. The method of claim 13, further comprising receiving selection input from a user, the selection input corresponding to the advertising information.

15. The method of claim 14, wherein the advertising information comprises a uniform resource locator (URL).

16. The method of claim 15, further comprising preventing user input unrelated to the URL.

17. The method of claim 13, wherein the presentation medium comprises a television broadcast.

18. The method of claim 17, wherein the program comprises one from a group consisting of a television program and a television advertisement.

19. The method of claim 13, wherein the presentation medium comprises a radio broadcast.

20. The method of claim 19, wherein the program comprises a movie theater advertisement.

21. The method of claim 13, wherein the program comprises a sporting event.

22. The method of claim 21, wherein the program comprises vendor advertising at a predetermined time interval relative to the sporting event.

23. A handheld device configured for operation with a presentation medium, the apparatus comprising:
a user interface module configured to
display, on a screen of the handheld device, advertising information, and
receive, from a user of the handheld device, input data associated with the advertising information; and
a communication module configured to
receive, from an information provider, the advertising information, the advertising information synchronized with programming played through the presentation medium, and
transmit, to a host computing system, user data associated with the advertising information.

24. The handheld device of claim 23, wherein the user interface module comprises a touch sensitive screen.

25. The handheld device of claim 23, wherein the presentation medium comprises a television.

26. The handheld device of claim 25, wherein the programming comprises one from a group consisting of a television program and a television advertisement.

27. The handheld device of claim 23, wherein the presentation medium comprises a movie theater.

28. The handheld device of claim 27, wherein the presentation medium comprises a sporting event.
